(19) United States
(12) Patent Application Publication
(10) Pub. No.: US 2003/0084123 A1
(43) Pub. Date: May 1, 2003

(54) Scheme for implementing FTP protocol in a residential networking architecture

(76) Inventor: Ibrahim M. Kamel, Princeton, NJ (US)

Correspondence Address: HARNESS, DICKEY & PIERCE, P.L.C., P.O. BOX 828, BLOOMFIELD HILLS, MI, 48303, US

(21) Appl. No.: 09/939,247

(22) Filed: Aug. 24, 2001

(51) Int. Cl. G06F 15/16

(52) U.S. Cl. 709/219; 709/246; 709/227

(57) ABSTRACT

A residential networking architecture and method for transferring files between a residential electronics device and a remote server provide reduced costs, simplified implementation and enhanced functionality. The method provides for establishing a proxy session with a file transfer protocol (FTP) client of the electronics device over a single connection communications link. An FTP session is established with the remote server over a dual connection communications link. The method further provides for mapping messages between the FTP session and the proxy session such that the messages are transferred between the electronics device and the remote server.

### BACKGROUND OF THE INVENTION

1. Technical Field

The present invention generally relates to networking architectures. More particularly, the invention relates to a residential networking architecture and method for transferring files between a residential electronics device and a remote server using the file transfer protocol.

2. Discussion

Although the Internet has often been referred to as one of the twentieth century's greatest communications developments, certain challenges still lie ahead. A particular challenge involves tailoring the various Internet protocols (IPs) to meet the ever changing needs of society. The hypertext transfer protocol (HTTP), the simple mail transfer protocol (SMTP) and the file transfer protocol (FTP) are but a few of the more popular protocols in use today. In particular, FTP enables networking terminals to retrieve files such as executable programs, movies, and music from the Internet. FTP has therefore become a mainstay to network computing.

FTP networking architectures typically involve maintaining an FTP session between an FTP server and an FTP client over a dual connection communications link. Request for comments (RFC) 959 is the official specification for FTP. Specifically, an FTP session requires two transmission control protocol (TCP) connections. The first connection is a control connection that is established in the normal client-server fashion. Thus, the server executes a passive open on a port (i.e., port 21) and waits for a client connection. The client executes an active open to the port in order to establish the control connection. The control connection stays “up” for the entire FTP session. It is well known that the control connection is used to transport commands from the client to the server and to transport server replies back to the client. The IP type-of-service setting for the control connection should be “minimize delay” since the commands are usually typed manually. The second connection is a data connection that is created each time a file is transferred between the client and the server. The IP type-of-service setting for the data connection should be “maximize throughput” since this connection is for file transfer.

As already noted, the control connection stays up for the duration of the client-server connection, but the data connection can come and go, as required. The control connection is typically responsible for sending FTP commands and getting FTP replies. Thus, the data connection is used in the following three cases: 1) sending a file from the client to the server, 2) sending a file from the server to the client, and 3) sending a listing of files or directories from the server to the client. The commands and replies sent across the control connection between the client and server are in NVT ASCII, which requires a carriage return/line feed pair at the end of each line. There are more than 30 different FTP commands that can be sent by the client to the server. The list is given in Table 1 as follows:

TABLE 1
FTP Commands

| | | | | | | | |
|---|---|---|---|---|---|---|---|
| USER | PASS | ACCT | CWD | CDUP | SMNT | REIN | QUIT |
| PORT | PASV | TYPE | STRU | MODE | RETR | STOR | STOU |
| APPE | ALLO | REST | RNFR | RNTO | ABOR | DELE | RMD |
| MKD | PWD | LIST | NLST | SITE | SYST | STAT | HELP |
| NOOP | | | | | | | |

The FTP replies are 3-digit numbers in ASCII, with an optional message following the number. For example, some typical replies, along with a possible message string are:

125 Data connection already open; transfer starting

200 Command OK

331 Username OK, password required

500 Syntax error (unrecognized command)

501 Syntax error (invalid arguments)

The above-described dual (control/data) connection communications link presents a number of difficulties with regard to home networking. For example, it is desired that a single connection communications link (e.g., IEEE 1394 Firewire serial data bus) be used to interconnect one or more home (or residential) electronics devices with the gateway required for connection to the Internet. This desire is primarily due to the fact that serial data busses are commercially available and already well defined in the market. For example, an individual might desire to transfer files between an FTP server and a digital video disk (DVD), a camcorder, and perhaps even a microwave using Firewire, which is carried by most major retail electronics stores. A serial bus network such as that provided by Firewire would therefore provide an acceptable solution to interconnecting the home electronics devices. Conventional FTP sessions, on the other hand, require two connections and therefore do not readily lend themselves to home networking. Furthermore, the costs associated with providing a dual connection communications link to each home electronics device can be prohibitive—particularly when the cost of the device itself it relatively low.

Another concern relates to the FTP client software required to implement file transfers. While typical computing devices (such as personal computers and servers) are commonly equipped with the necessary software to fully implement FTP transfers, such a solution is often unacceptable in the home electronics devices context. Once again, this limitation is largely due to the fact that the typical home electronics device is not nearly as expensive as a standard computing device and could therefore double in cost if manufactured with a fully functional FTP client. It is therefore desirable to provide a mechanism for transferring files between a standard FTP server and a relatively inexpensive home electronics device.

Thus, residential networking differs fundamentally from commercial networking in a number of important aspects. The costs associated with implementing a networking architecture are typically more easily borne by a business than an individual resident primarily because the costs can be “passed on” to consumers to some extent. Thus, a dual connection communications link with each networking terminal would not be nearly as cost prohibitive to the business. The individual resident, on the other hand, would likely be quite reluctant to implement such an architecture. Furthermore, the networking terminals in a commercial setting are typically more expensive than the devices found in the average home. Thus, the installation of FTP client software in home appliances is not a viable alternative, while such an approach is commonplace in a commercial environment.

The above and other objectives are provided by a method for transferring files between a residential electronics device and a remote server in accordance with principles of the present invention. The method includes the step of establishing a proxy session with an FTP client of the electronics device over a single connection communications link. An FTP session is established with the remote server over a dual connection communications link. The method further provides for mapping messages between the FTP session and the proxy session such that the messages are transferred between the electronics device and the remote server. Thus, the use of a proxy session enables an efficient redistribution of FTP functions and results in a commercially acceptable approach to residential networking.

Further in accordance with the present invention, a method for mapping messages between an FTP session and a proxy session is provided. The method provides for defining a proxy messaging structure for the proxy session. Incoming FTP messages received from an FTP server are converted into outgoing proxy messages having the proxy messaging structure. The method further provides for converting incoming proxy messages received from an FTP client into outgoing FTP messages, wherein the incoming proxy messages have the proxy messaging structure.

In another aspect of the invention, a residential networking architecture has an electronics device, a web proxy functional component module (FCM) and a serial bus network. The electronics device has an FTP client, and the web proxy FCM maintains a proxy session with the proxy client. The web proxy FCM further maintains an FTP session with a remote server over a dual connection communications link. The serial bus network provides a single communications link between the proxy client and the web proxy FCM.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute part of this specification. The drawings illustrate various features and embodiments of the invention, and together with the description serve to explain the principles and operation of the invention.

### BRIEF DESCRIPTION OF THE DRAWINGS

The various advantages of the present invention will become apparent to one skilled in the art by reading the following specification and subjoined claims and by referencing the following drawings, in which:

FIG. 1 is a flowchart of a method for transferring files between a residential electronics device and a remote server in accordance with the principles of the present invention;

FIG. 2 is a flowchart of a process for mapping messages between an FTP session and a proxy session in accordance with the principles of the present invention;

FIG. 3 is a block diagram showing implementation of a shared messaging structure for a proxy session in accordance with one embodiment of the present invention;

FIG. 4 is a block diagram showing implementation of a dedicated messaging structure for a proxy session in accordance with a first alternative embodiment of the present invention;

FIG. 5 is a block diagram showing implementation of a hypertext transfer protocol messaging structure for a proxy session in accordance with a second alternative embodiment of the present invention;

FIG. 6 is a flowchart demonstrating a process for establishing a proxy session in accordance with the principles of the present invention;

FIG. 7 is a flowchart of a process for establishing an FTP session in accordance with the principles of the present invention;

FIG. 8 is a block diagram showing communication between device applications and an FTP agent in accordance with the principles of the present invention;

FIG. 9 is a block diagram showing a web proxy functional component module (FCM) in accordance with the principles of the present invention;

FIG. 10 is a block diagram showing synchronous communication between a device application and a web proxy FCM in accordance with one embodiment of the present invention;

FIG. 11 is a block diagram showing asynchronous communication between a device application and a web proxy FCM in accordance with an alternative embodiment of the present invention; and

FIG. 12 is a block diagram showing a residential networking architecture in accordance with the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

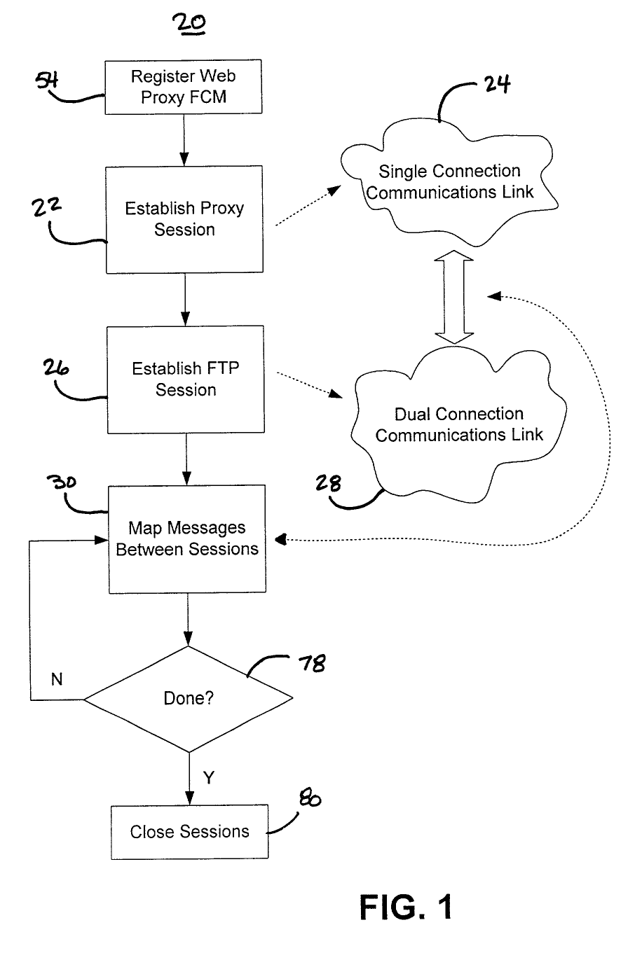

Turning now to FIG. 1, it can be seen that the present invention provides a method 20 for transferring files between a residential (or home audio/video interoperability—HAVi) electronics device and a remote server. Generally, the method 20 includes the step 22 of establishing a proxy session with a proxy client of the electronics device over a single connection communications link 24. A file transfer protocol (FTP) session is established with the remote server at step 26 over a dual connection communications link 28. At step 30 messages are mapped between the FTP session and the proxy session such that the messages are transferred between the electronics device and the remote server. By enabling the use of the single connection communications link 24, the present invention provides a unique and cost effective solution to residential networking.

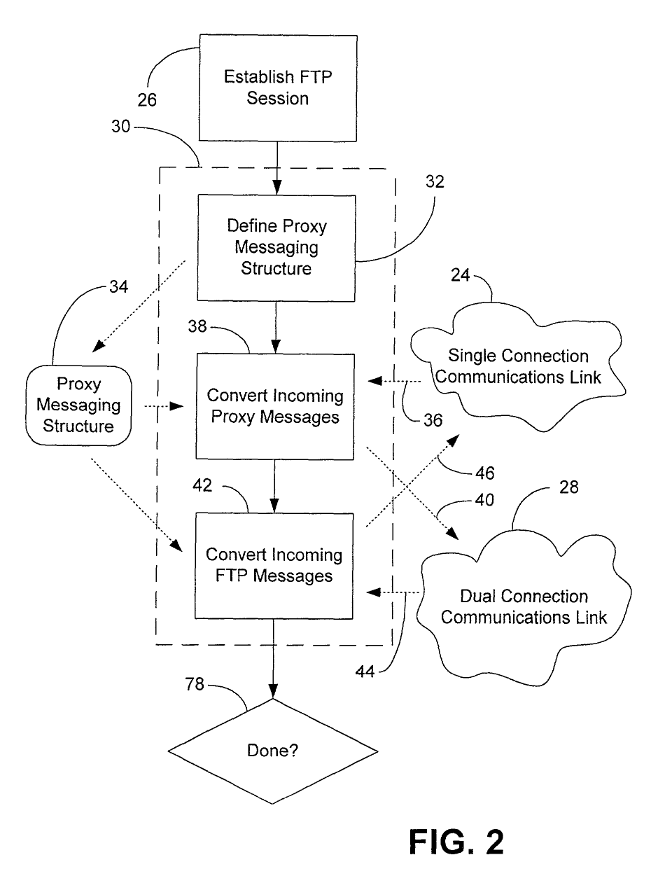

FIG. 2 illustrates the preferred approach to mapping messages between the FTP session and the proxy session at step 30 in greater detail. Specifically, it can be seen that at step 32 a proxy messaging structure 34 is defined for the proxy session. The proxy messaging structure 34 is typically defined at the system design stage, but can be defined at other stages of implementation, as desired. Incoming proxy messages 36 received from the FTP client (over link 24) and having the proxy messaging structure 34 are converted at step 38 into outgoing FTP messages 40. It can further be seen that step 42 provides for converting incoming FTP messages 44 received from the FTP server (over link 28) into outgoing proxy messages 46. It will be appreciated that the outgoing proxy messages 46 also have the proxy messaging structure 34.

As will be discussed in greater detail below, an FTP agent is used as an intermediary between the proxy session and the FTP session. It will therefore be appreciated that there are two connections between the FTP agent and the FTP server, while there is only one connection between the FTP agent and the FTP client. The proxy messaging structure 34 therefore serves an important function. This function is to enable the FTP agent to map command content and data content between the dual connection communications link 28 and the single connection communications link 24.

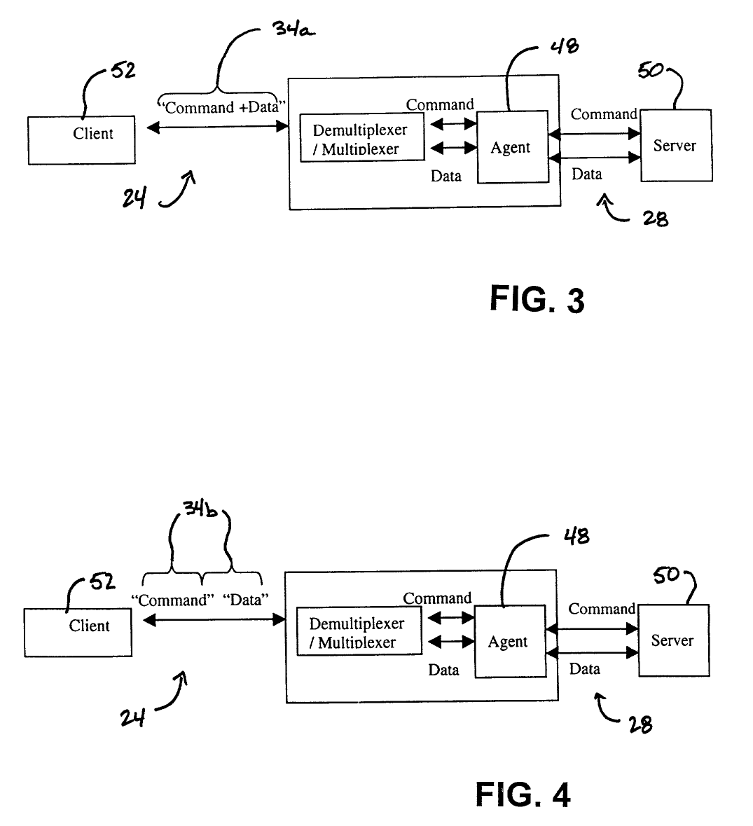

FIG. 3 illustrates one approach to implementing a proxy messaging structure. It can be seen that an FTP agent 48 is activated for the FTP client 52, and serves as a proxy for the FTP server 50. Thus, communications between the agent 48 and the server 50 constitute the FTP session, whereas communications between the agent 48 and the client 52 constitute the proxy session. It can also be seen that a shared messaging structure 34a is defined for the proxy session such that each proxy message includes a shared message having a control field and a data field. The control field contains control content for a corresponding FTP message, while the data field contains data content for the corresponding FTP message. It is preferred that the control field is defined as being a message header of the shared message and that the data field is defined as being a message body of the shared message.

Thus, the shared message approach is similar to the HTTP protocol. Each message (request or response) includes two parts. The first part (i.e., the message header) will be the FTP command (for a request message) or the FTP reply (for a response message). The second part (i.e., the message body) is optional and contains the data content to be transferred, if there is any. For example, when the FTP client 52 wants to store a file to the FTP server 50, the message body is the content of the file to be stored. The message header is separated from the message body with a new line character. Both the FTP client 52 and the FTP agent 48 are intelligent enough to parse the command/reply from the incoming message and treat the rest of the message as the data content.

It will be appreciated that there are essentially three categories of the FTP commands. The first category is the case wherein no data needs to be transferred between the FTP client 52 and the FTP agent 48. USER, PASS and PWD are examples of this type of command. In this case, the FTP agent 48 will forward the FTP reply to the device application via the FTP client 52. The response for this type of FTP command will be sent through the control connection. Thus, both the request messages (to the FTP agent 48) and the response messages (from the FTP agent 48) include only the message header with an empty message body.

Another category is the case wherein the FTP command requires data to be transferred from the FTP agent 48 to the FTP client 52. NLST and RETR are examples of this type of command. In this case, the request message from the FTP client 52 includes an empty message body and the response message to the FTP client 52 includes a non-empty message body that contains the data to be transferred to the FTP client 52.

A third category is the case wherein the FTP command requires data to be transferred from the FTP client 52 to the FTP agent 48. STOR, STOU and APPE are examples of this type of command. In this case, the request message from the FTP client 52 to the FTP agent 48 includes a non-empty message body that contains the data to be transferred to the FTP server 50 and the response message from the FTP agent 48 to the FTP client 52 includes only the message header.

While the above-described shared messaging approach is acceptable when processing overhead is not a major concern, it is preferred that the dedicated messaging approach illustrated in FIG. 4 is used. Specifically, it can be seen that a dedicated messaging structure 34b is defined for the proxy session such that each FTP message maps to a dedicated control message. The dedicated control message contains control content for the FTP message. It can further be seen that where data content needs to be transported, the FTP message also maps to a dedicated data message such that the dedicated data message contains data content for the FTP message. Thus, the FTP commands/replies and the FTP data content are not being multiplexed into one message. Instead, they are being transferred between the FTP client 52 and the FTP agent 48 in separate messages.

For example, when the FTP client 52 sends the RETR FTP command, there are three messages that are going to be sent from the FTP agent 48 to the FTP client 52. The first message will contain the first positive preliminary reply, the second message will contain the data content and the third message will contain the positive completion reply. Both the FTP client 52 and the FTP agent 48 are intelligent enough to know that the FTP command or the FTP reply that they receive is associated with data content, and can therefore process the following messages accordingly. It will be appreciated that this approach requires the least amount of logic to be added to the FTP client 52 in order to successfully communicate with the FTP agent 48.

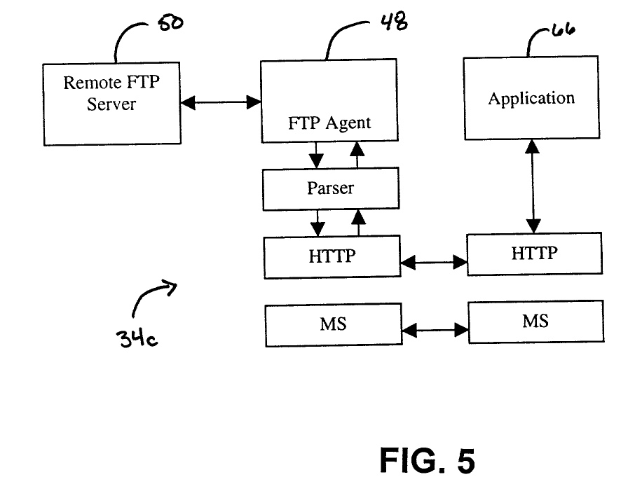

Turning now to FIG. 5, a second alternative approach to defining a proxy messaging service is shown. Specifically, it can be seen that an HTTP messaging structure 34c is defined for the proxy session such that each FTP message maps to an HTTP message.

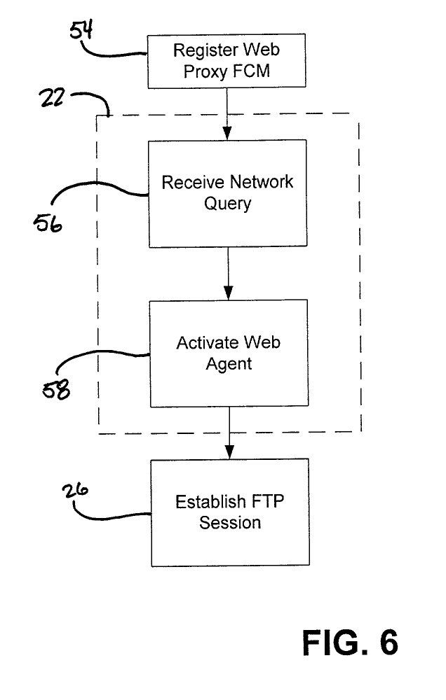

Turning now to FIG. 6, the preferred approach to establishing a proxy session is shown in greater detail at step 22. It should be noted at the outset that a web proxy functional component module (FCM) is registered with a home network including the FTP client at step 54. It will be appreciated that the purpose of the registry service is to manage a directory of software elements available within the home network. The software elements are part of the various device applications installed on one or more residential devices, where the residential devices are connected to the home network. The web proxy FCM, on the other hand, is resident on the gateway device that interconnects the home network with the Internet. The web proxy FCM is registered so that it can be found and contacted by other software elements in the network.

The registry service maintains, for each registered software element, a corresponding identifier (SEID) and associated attributes in the registry database. There are preferably fourteen predefined registry attributes. Nine of these attributes are mandatory for a FCM: SoftwareElementType, VendorId, HUID, Targetid, InterfaceId, DeviceClass, DeviceManufacture, SoftwareElementVersion and UserPreferredName. In the implementation of the web proxy only the mandatory attributes are defined. The attributes are used to characterize a software element. Each attribute can be defined in the following structure:

struct Attribute{

AttributeName name;

sequence<octet. value;

};

The attribute name indicates the name of an attribute, and the attribute value is the value for that attribute name.

Thus, an FTP client can easily find the web proxy FCM by specifying one of these nine attributes in a simple query. Some of the attribute names used to define the web proxy FCM and their corresponding values are shown in Table 2. The DeviceClass of the WebProxy FCM is a FAV (Full AV Device).

TALBE 2

| Attribute Name | Attribute Value |
|---|---|
| SoftwareElementType | WEBPROXY_FCM |
| DeviceClass | FAV |
| DeviceManufacturer | 37 Panasonic” |
| UserPreferredName | “WebProxy_FCM” |

The web proxy FCM registers itself through the registry service in the construction of the WebProxy class. The declaration of the registration method WebProxyRegistration in the WebProxy class is as follows:

public void WebProxyRegistration (SoftwareElement se)

{. . . }

This method will do the following:

1) Create an instance of class RegistryLocalClient, which provides the methods to access the specified Registry System Component. The methods construct appropriate messages and send them to the Registry System Component; 2) Create an attribute list that contains nine attributes SoftwareElementType, VendorId, HUID, TargetId, InterfaceId, DeviceClass, DeviceManufacturer, SoftwareElementVersion and UserPreferredName for the web proxy FCM; and 3) Register the attribute list with the registry service using the method registerElement of the RegistryLocalClient class.

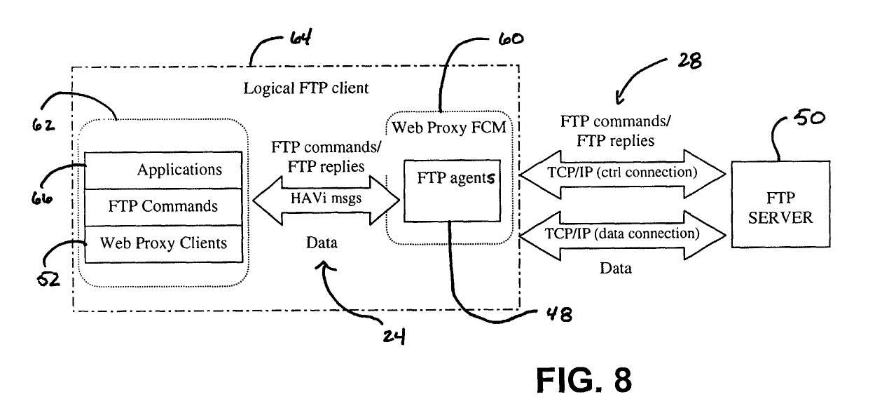

Thus, it can be seen that at step 56 a network query is received for the web proxy FCM from one of the FTP clients. A web agent is activated for the FTP client at step 58. FIG. 8 illustrates that the web proxy FCM 60 and the remainder of the device applications 66 on the home network 62 (including the various proxy sessions) make up a “logical” FTP client 64. The internal messaging structures of the logical FTP client 64 are transparent to the FTP server 50, which only requires knowledge of standard FTP commands and replies.

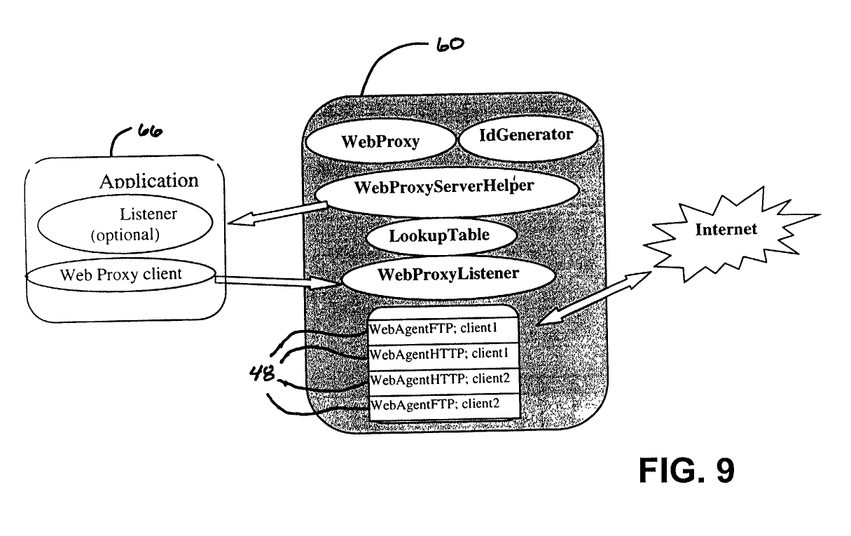

Turning now to FIG. 9, it will be appreciated that the proxy session can be viewed as a client-server model. At the client side, an object of class WebProxyClient, sends requests to the web proxy FCM through the messaging system. After the server handles the requests, it invokes the appropriate methods in the helper class, called WebProxyServerHelper, to send the responses back to the WebProxyClient. If the request is synchronous, the response will come back directly. And if the request is asynchronous, the response will come back indirectly through a listener using WebProxyListener.

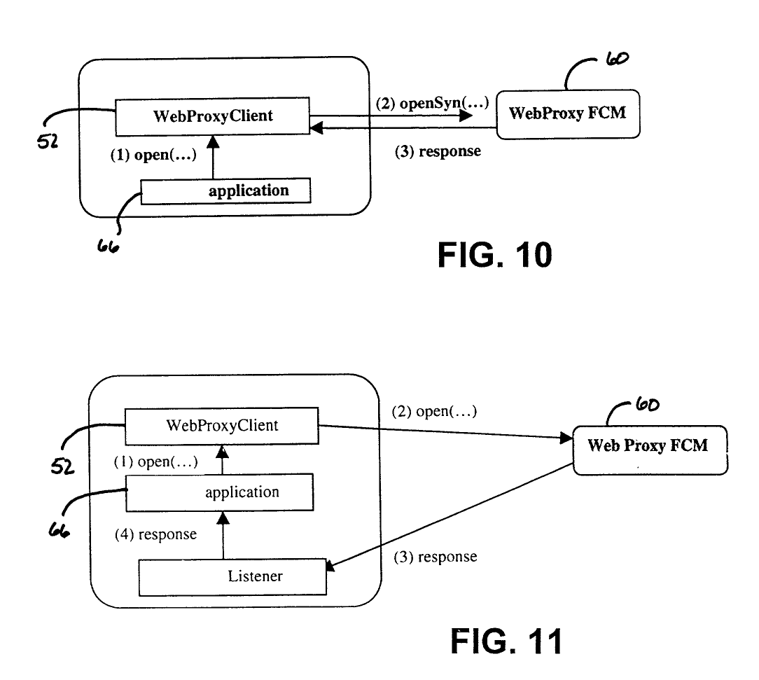

FIGS. 10 and 11 illustrate synchronous and asynchronous communication for the proxy session, respectively. In both cases, the web proxy FTP client 52 object sends the request message to the web proxy FCM 60 through the local messaging system by invoking different methods of the local software element. In the case of synchronous communication, the method msgSendRequestSync is invoked and does not return to the caller until it receives the response (including data) from the web proxy FCM 60. In the case of asynchronous communication, the method msgSendRequest is invoked and it returns immediately with a transactionld. Later, the web proxy FTP client 52 uses transactionid to obtain the corresponding response. Thus, the client 52 does not need to keep waiting while the web proxy FCM 60 is handling the request. It is easy to understand that the asynchronous communication is more efficient because it overlaps communication and computation time. The device application 66 has the capability to choose the type of communication. For synchronous communications, the application 66 invokes the openSync, sendSync, closeSync, and getCapabilitySync methods of the WebProxyClient class. And for asynchronous communications, the application 66 needs to install the appropriate HAViListeners and invokes Open, Send, Close and GetCapability methods of the WebProxyClient class.

Briefly, there are four APIs for the web proxy FCM: Open, Close, Send and GetCapability. The Open and Close APIs handle establishing and closing an Internet connection respectively. The Send API handles sending requests to the remote servers on the Internet. To receive the responses from the remote servers, the web proxy FTP client must provide a method for complying with the <Client>::Receive API. The prototypes of the APIs are given in the interface design language (IDL) as follows:

Status WebProxy::Open(

in ProtocolType protocol,

in short clientBufferSize,

in OperationCode opCode,

in WebAddress address,

in uint portNumber,

out long cid,

out short proxyBufferSize)

Status WebProxy::Close (in long cid)

Status WebProxy::Send(

in long cid,

in FileLoc where,

in sequence<octet>webData)

Status WebProxy::GetCapability(

out sequence<boolean>protocolList,

out sequence<boolean>typeList)

Status <Client>::Receive(

in long cid,

in FileLoc where,

in sequence<octet>webData)

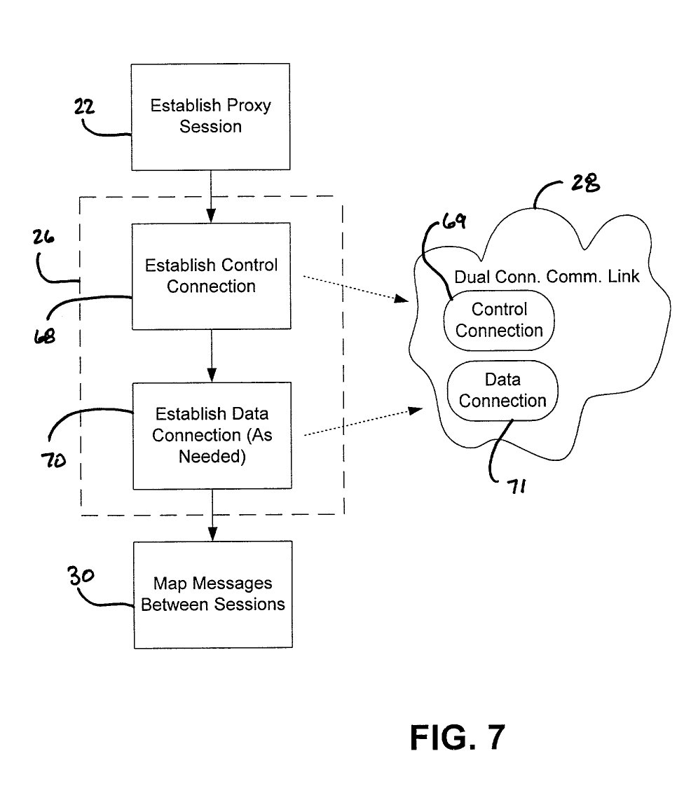

Turning now to FIG. 7, the preferred approach to establishing an FTP session is shown in greater detail at step 26. It can be seen that at step 68 a control connection 69 is established between the web proxy FCM and the remote server. Step 70 provides for establishing a data connection 71 between the web proxy and the remote server.

Returning now to FIG. 1, it can be seen that when the communications between the FTP server and the proxy client are determined to be complete at step 78, method 20 further provides for closing the FTP and proxy sessions at step 80. Specifically, in existing FTP applications, when an FTP client sends a “QUIT” command to a remote FTP server, the control connection with the remote FTP server is closed. However, under the present invention the connection with a remote FTP server is closed by invoking the method close( ) of class WebProxy. There are three possible approaches to handling the “QUIT” FTP command.

The first approach involves the FTP client sending a “QUIT” command to the web proxy. The web proxy closes the connection with the remote FTP server and removes the FTP Agent for that connection from the Lookup Table. If after this, the FTP client sends another FTP command, the web proxy sends an error message to the FTP client indicating that the FTP agent for the connection does not exist any more. This approach assures better use of the system resources and proper cleanup.

Another approach involves the FTP client sending a “QUIT” command to the FTP Agent. The FTP Agent then closes the connection with the Remote FTP host. If after this, the FTP client sends another FTP command, the FTP Agent sends an error message to the FTP client indicating that the connection with the Remote FTP host was closed.

A third approach involves the FTP client sending a “QUIT” command to the FTP Agent and the FTP Agent closing the connection with the Remote FTP host. If after this, the FTP client sends another FTP command, the FTP Agent reestablishes the control connection with the Remote FTP host and continues to forward the FTP command.

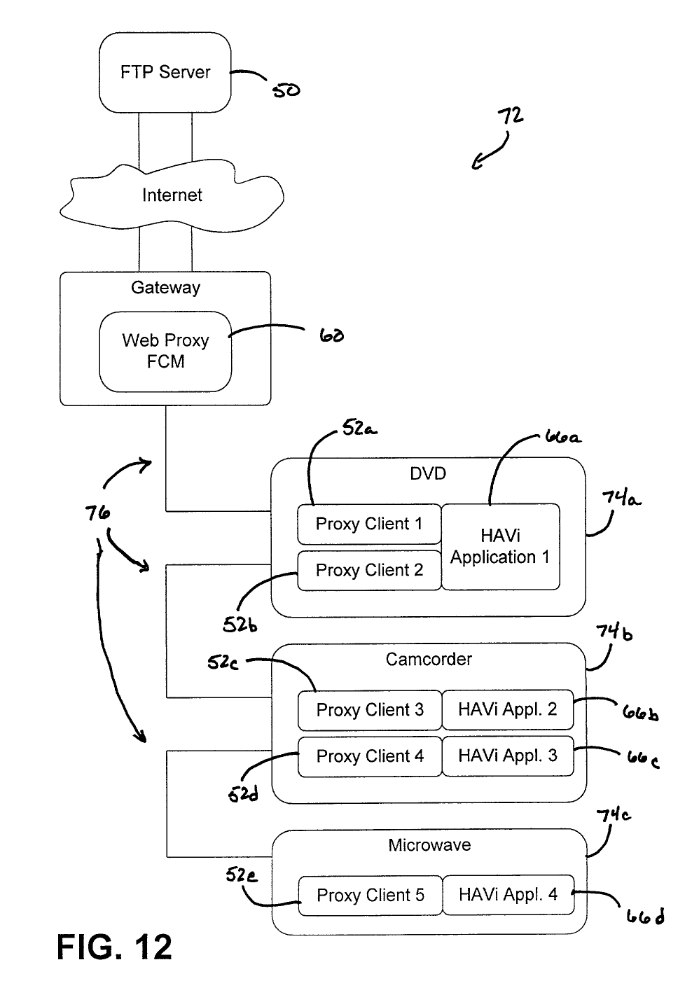

Turning now to FIG. 12, one approach to implementing a residential networking architecture is shown generally at 72. Generally, it can be seen that each electronics device 74 has one or more FTP clients 52. The web proxy FCM 60 maintains a proxy session with the FTP clients 52, and further maintains an FTP session with the remote FTP server 50 over a dual connection communications link. A serial bus network 76 provides a single communications link between the FTP clients 52 and the web proxy FCM 60. It is highly preferred that the electronics devices 74 are daisy-chained together in accordance with IEEE 1394.

Those skilled in the art can now appreciate from the foregoing description that the broad teachings of the present invention can be implemented in a variety of forms. Therefore, while this invention can be described in connection with particular examples thereof, the true scope of the invention should not be so limited since other modifications will become apparent to the skilled practitioner upon a study of the drawings, specification and following claims.

What is claimed:

1. A method for transferring files between a residential electronics device and a remote server, the method comprising the steps of:
establishing a proxy session with a file transfer protocol (FTP) client of the electronics device over a single connection communications link;
establishing a FTP session with the remote server over a dual connection communications link; and
mapping messages between the FTP session and the proxy session such that the messages are transferred between the electronics device and the remote server.

2. The method of claim 1 further including the steps of:
defining a proxy messaging structure for the proxy session;
converting incoming FTP messages received from the FTP server into outgoing proxy messages having the proxy messaging structure; and
converting incoming proxy messages received from the FTP client into outgoing FTP messages, wherein the incoming proxy messages have the proxy messaging structure.

3. The method of claim 2 further including the step of:
defining a shared messaging structure for the proxy session such that each proxy message includes a shared message having a control field and a data field;
said control field containing control content for a corresponding FTP message;
said data field containing data content for the corresponding FTP message.

4. The method of claim 3 further including the step of defining the control field as being a message header of the shared message.

5. The method of claim 3 further including the step of defining the data field as being a message body of the shared message.

6. The method of claim 3 further including the step of defining the data field of the shared message to be empty when there is no data content for the corresponding FTP message.

7. The method of claim 2 further including the step of:
defining a dedicated messaging structure for the proxy session such that each FTP message maps to a dedicated control message;
said dedicated control message containing control content for the FTP message.

8. The method of claim 7 further including the step of mapping the FTP message to a dedicated data message such that the dedicated data message contains data content for the FTP message.

9. The method of claim 2 further including the step of defining a hypertext transfer protocol (HTTP) messaging structure for the proxy session such that each FTP message maps to an HTTP message.

10. The method of claim 1 further including the step of registering a web proxy functional component module (FCM) with a home network including the FTP client.

11. The method of claim 10 further including the steps of:
receiving a network query for the web proxy FCM from the FTP client; and
activating a web agent for the FTP client.

12. The method of claim 10 further including the steps of:
establishing a control connection between the web proxy FCM and the remote server;
establishing a data connection between the web proxy and the remote server; and
said web proxy being remotely located from the electronics device.

13. A method for mapping messages between a file transfer protocol (FTP) session and a proxy session, the method comprising the steps of:
defining a proxy messaging structure for the proxy session;
converting incoming FTP messages received from a FTP server into outgoing proxy messages having the proxy messaging structure; and
converting incoming proxy messages received from a FTP client into outgoing FTP messages, wherein the incoming proxy messages have the proxy messaging structure.

14. The method of claim 13 further including the step of:
defining a shared messaging structure for the proxy session such that each proxy message includes a shared message having a control field and a data field;
said control field containing control content for a corresponding FTP message;
said data field containing data content for the corresponding FTP message.

15. The method of claim 14 further including the step of defining the control field as being a message header of the shared message.

16. The method of claim 14 further including the step of defining the data field as being a message body of the shared message.

17. The method of claim 13 further including the step of:
defining a dedicated messaging structure for the proxy session such that each FTP message maps to a dedicated control message;
said dedicated control message containing control content for the FTP message.

18. The method of claim 17 further including the step of:
mapping the FTP message to a dedicated data message;
said dedicated data message containing data content for the FTP message.

19. The method of claim 13 further including the step of defining a hypertext transfer protocol (HTTP) messaging structure for the proxy session such that each FTP message maps to an HTTP message.

20. A residential networking architecture comprising:
an electronics device having a file transfer protocol (FTP) client;
a web proxy functional component module (FCM) for maintaining a proxy session with the FTP client, the web proxy FCM further maintaining a file transfer protocol (FTP) session with a remote server over a dual connection communications link; and
a serial bus network for providing a single communications link between the FTP client and the web proxy FCM.

21. The networking architecture of claim 20 wherein the web proxy FCM includes:
a lookup table containing a table of active web agents;
a server module for maintaining the lookup table; and
a helper module using the lookup table to generate responses to messages received from the proxy session and the FTP session.

22. The networking architecture of claim 21 wherein the FCM further includes a listening module, the listening module for receiving messages from the proxy session and the FTP session.

23. The networking architecture of claim 21 wherein the FCM further includes an identification module for allocating and de-allocating client identifiers.

24. The networking architecture of claim 20 wherein the electronics device is a digital video disk machine.

25. The networking architecture of claim 20 wherein the electronics device is a camcorder.

26. The networking architecture of claim 20 wherein the electronics device is a microwave.
